(19) United States
(12) Patent Application Publication
(10) Pub. No.: US 2023/0317054 A1
(43) Pub. Date: Oct. 5, 2023

(54) FACE IMAGE PROCESSING SYSTEM, FACE IMAGE GENERATION INFORMATION PROVIDING APPARATUS, FACE IMAGE GENERATION INFORMATION PROVIDING METHOD, AND FACE IMAGE GENERATION INFORMATION PROVIDING PROGRAM

(71) Applicant: EMBODYME, INC., Tokyo (JP)

(72) Inventors: Issei YOSHIDA, Tokyo (JP); Hikari YANAGAWA, Tokyo (JP)

(21) Appl. No.: 18/250,251

(22) PCT Filed: Nov. 10, 2020
(86) PCT No.: PCT/JP2020/041819

§ 371 Date: Apr. 24, 2023

(30) Foreign Application Priority Data
Oct. 29, 2020 (JP) 2020-181126

(51) Int. Cl. G10L 13/027; G10L 25/63; G06V 40/16

(52) U.S. Cl. CPC G10L 13/027; G10L 25/63; G06V 40/161

(57) ABSTRACT

A server device 100 includes an estimation neutral expression parameter generation unit 104 generating an estimation neutral expression parameter indicating a face neutral expression estimated from a dialogue sound generated in accordance with dialogue information of a user, an appearance neutral expression parameter generation unit 107 generating an appearance neutral expression parameter indicating a face neutral expression appearing on a captured face image obtained by capturing a face of an operator, and a neutral expression parameter transmission unit 110 selecting either the estimation neutral expression parameter or the appearance neutral expression parameter to transmit to a client device, and in the client device, by applying a neutral expression specified on the basis of the neutral expression parameter transmitted from the server device 100 to a target face image, a face image of a neutral expression corresponding to the dialogue sound or the captured face image of the operator generated by the server device 100 is generated.

### TECHNICAL FIELD

The present invention relates to a face image processing system, a face image generation information providing apparatus, a face image generation information providing method, and a face image generation information providing program, and in particular, is suitable to be used in a system in which a face image adjusted with a neutral expression of another person can be generated by applying the face neutral expression of the another person to a face image of a synthetic target.

### BACKGROUND ART

In the related art, a technology is provided in which the neutral expression of a face image of another person is synthesized with respect to a face image of a person to be a synthetic target (hereinafter, may be referred to as a target face image) to be displayed (for example, refer to NPL 1). In the technology described in NPL 1, several neutral expression parameters indicating the face neutral expression of the another person are extracted from a moving image including the face of the another person while extracting several neutral expression parameters indicating the position of the face and the neutral expression from the face image of the synthetic target, and the neutral expression parameter of the target face image is adjusted by using the neutral expression parameter of the another person, and thus, each part of the target face image such as the eyes, the nose, and the mouth is deformed.

In addition, a technology is also known in which the face neutral expression is estimated from a sound, and the estimated face neutral expression is synthesized with respect to the target face image to be displayed (for example, refer to PTLs 1 and 2). In a video phone terminal device described in PTL 1, basic face data indicating the size, the position, or the like of each part of the face such as the outline, the eyes, and the mouth is generated on the basis of a user manipulation while generating neutral expression data for adding the neutral expression to the face image on the basis of a sound signal input from a sound input unit. Then, a portrait image of a speaker is created as a moving image by combining the basic face data and the neutral expression data.

In a face image transmission system described in PTL 2, a neutral expression estimation model of a neural network for estimating the neutral expression of the speaker from the sound of the speaker is subjected to machine learning and is set on the reception side, and the sound of the speaker is transmitted to the reception side from the transmission side and is applied to the neutral expression estimation model, and thus, the neutral expression of the speaker is estimated, and a moving image of the estimated neutral expression of the speaker is generated.

A system is also known in which the face neutral expression and the shape of the mouth are reproduced from another parameter (for example, refer to PTL 3). In the system described in PTL 3, processing such as neutral expression analysis and neutral expression parameter conversion is performed with respect to the face original image, and thus, a mouth shape parameter is obtained by performing processing such as characteristics extraction, phoneme recognition, and mouth shape parameter conversion with respect to the original sound while obtaining a neutral expression deformation parameter (other than the mouth) with respect to a three-dimensional model. Then, a decryption image is obtained by deforming the three-dimensional model with the neutral expression deformation parameter and the mouth shape parameter.

### CITATION LIST

### Patent Literature

PTL 1: JP2005-57431A

PTL 2: JP3485508B

PTL 3: JPH05-153581A

### Non Patent Literature

NPL 1: “Xpression: mobile real-time facial expression transfer” (SA'18: SIGGRAPH Asia 2018 Emerging Technologies, December 2018, Article No. 18)

### SUMMARY OF INVENTION

### Technical Problem

By using the technologies in PTLs 1 to 3 or NPL 1 described above, the face image in which the neutral expression of the speaker is synthesized with respect to the target face image can be generated to be displayed. By further developing such technologies, an object of the invention is to enable a face image in which a neutral expression is adjusted in accordance with a situation when a dialogue is performed to be displayed.

### Solution to Problem

In order to attain the object described above, in a face image processing system of the invention, in a server device, an appearance neutral expression parameter indicating a face neutral expression appearing on a captured face image obtained by capturing a face of a person is generated on the basis of the captured face image while generating an estimation neutral expression parameter indicating a face neutral expression estimated from a dialogue sound generated in accordance with dialogue information of a user, which is sent from a client device, on the basis of the dialogue sound, and either the estimation neutral expression parameter or the appearance neutral expression parameter is selected and transmitted to the client device. Then, in the client device, a face image of a neutral expression corresponding to the dialogue sound or the captured face image of the person generated by a computer of the server device is generated by applying a neutral expression specified on the basis of the neutral expression parameter transmitted from the server device to a target face image.

### Advantageous Effects of Invention

According to the invention configured as described above, in a situation where a dialogue is performed between the user of the client device and the computer of the server device or a dialogue is performed between the user of the client device and the person on the server device side, it is possible to generate the face image in which the neutral expression is adjusted to correspond to either the dialogue sound of the computer or the captured face image of the person in the client device. Accordingly, according to the invention, it is possible to display the face image in which the neutral expression is adjusted in accordance with the situation when the dialogue is performed on the client device.

### BRIEF DESCRIPTION OF DRAWINGS

FIG. 1 is a diagram illustrating a configuration example of a face image processing system according to this embodiment.

FIG. 2 is a block diagram illustrating a functional configuration example of a server device according to this embodiment.

FIG. 3 is a block diagram illustrating a functional configuration example of a client device according to this embodiment.

FIG. 4 is a flowchart illustrating an operation example of the server device according to this embodiment.

### DESCRIPTION OF EMBODIMENTS

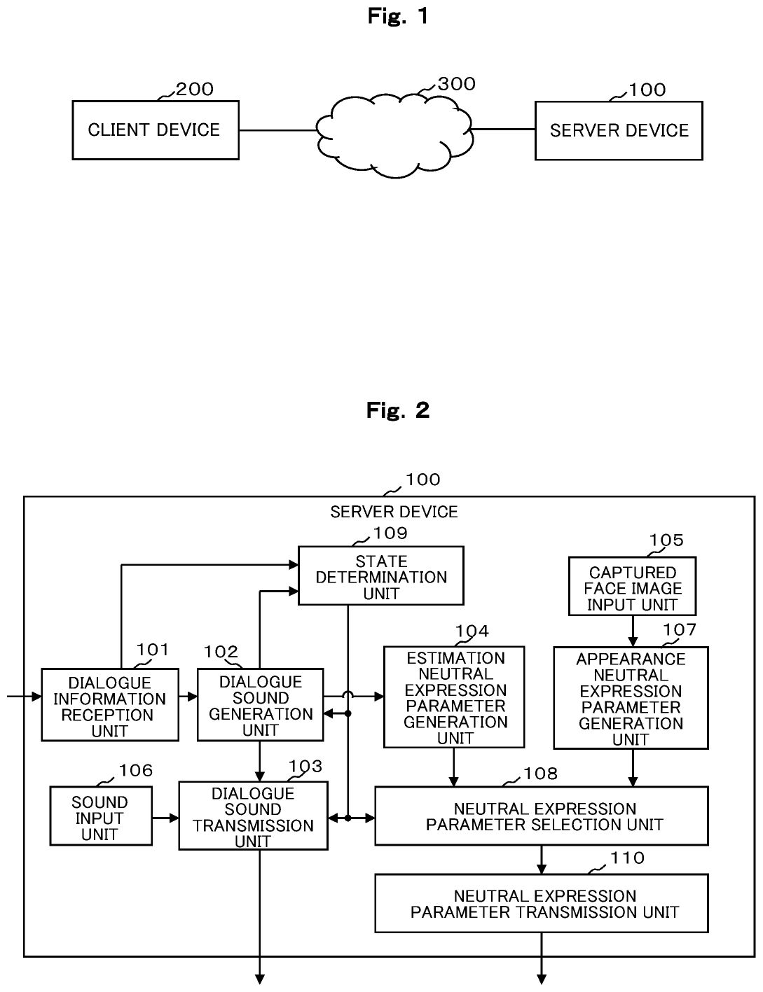

Hereinafter, one embodiment of the invention will be described on the basis of the drawings. FIG. 1 is a diagram illustrating a configuration example of a face image processing system according to this embodiment. As illustrated in FIG. 1, in the face image processing system according to this embodiment, a server device 100 and a client device 200 are connected through a communication network 300 such as the internet or a mobile telephone network.

In the face image processing system according to this embodiment, as an example, a dialogue using a sound and an image is performed between a user of the client device 200 and a computer of the server device 100. For example, the user sends any question or request (corresponding to dialogue information in the claims) to the server device 100 from the client device 200, and the server device 100 returns a response with respect to the question or the request to the client device 200. Accordingly, the server device 100 has a so-called chatbot function.

Here, the question or the request transmitted from the client device 200 may be text information input to the client device 200 by the user using a manipulation device such as a keyboard or a touch panel, or may be speaking sound information input to the client device 200 by the user using a microphone. Alternatively, the question or the request may be a tone signal transmitted when manipulating a dial key of a phone that is associated with a predetermined question or request, a control signal transmitted in accordance with a predetermined manipulation, or the like. On the other hand, the response returned from the server device 100 is synthetic sound information converted from the text information for a response that is generated by using a predetermined rule-based or machine-learned analysis model. Note that, the text information may be returned together with synthetic sound information.

Here, an example of using a synthetic sound as the response to the client device 200 from the server device 100 has been described, but the embodiment is not limited thereto. For example, for a case where it is sufficient to return a response with fixed contents to the predetermined question or request, a sound obtained by a person speaking response contents may be recorded in advance and stored in a database, and the recorded sound may be read out from the database and returned. Note that, hereinafter, in order to simplify the description, it will be described that the synthetic sound information is used in the return to the client device 200 from the server device 100.

In this embodiment, in accordance with the return of the response to the client device 200 from the server device 100, a face image in which the neutral expression is changed in accordance with the synthetic sound of the response is displayed on the client device 200. In this embodiment, in particular, several parameters relevant to the neutral expression (hereinafter, referred to as a neutral expression parameter) are transmitted to the client device 200 from the server device 100, and in the client device 200, the neutral expression of a target face image prepared in advance is adjusted by the neutral expression parameter, and thus, the face image of the neutral expression corresponding to the synthetic sound of the response is generated and displayed. The details thereof will be described below.

Note that, here, as an example, it has been described that the question or the request is performed with respect to the server device 100 from the user of the client device 200, and the chatbot of the server device 100 performs the response, but the contents of the dialogue are not limited thereto. For example, contents in which the question is performed with respect to the user of the client device 200 from the chatbot of the server device 100, and the user of the client device 200 performs the response may be included in a set of dialogues to be repeated. In addition, the user of the client device 200 and the chatbot of the server device 100 may perform a dialogue that is not in the form of questions and answers.

In this embodiment, in addition to the dialogue between the user of the client device 200 and the chatbot of the server device 100, a dialogue may be performed between the user of the client device 200 and an operator on the server device 100 side. That is, a dialogue with the chatbot and a dialogue with the operator may be suitably switched. In a case where the dialogue is performed between the user and the operator, a face image in which the neutral expression is changed in accordance with the response of the operator with respect to the user is displayed on the client device 200. Even in this case, the neutral expression parameter is transmitted to the client device 200 from the server device 100, and the neutral expression of the target face image prepared in advance is adjusted by the neutral expression parameter, and thus, the face image of the neutral expression according to the response of the operator is generated and displayed.

FIG. 2 is a block diagram illustrating a functional configuration example of the server device 100 of this embodiment. As illustrated in FIG. 2, the server device 100 according to this embodiment includes a dialogue information reception unit 101, a dialogue sound generation unit 102, a dialogue sound transmission unit 103, an estimation neutral expression parameter generation unit 104, a captured face image input unit 105, a sound input unit 106, an appearance neutral expression parameter generation unit 107, a neutral expression parameter selection unit 108, a state determination unit 109, and a neutral expression parameter transmission unit 110, as a functional configuration.

Here, functions provided by the dialogue information reception unit 101, the dialogue sound generation unit 102, and the dialogue sound transmission unit 103 are a chatbot function, and a known technology can be applied. In addition, the estimation neutral expression parameter generation unit 104, the appearance neutral expression parameter generation unit 107, the neutral expression parameter selection unit 108, the state determination unit 109, and the neutral expression parameter transmission unit 110 correspond to the constituents of a face image generation information providing apparatus according to the invention.

Each of the functional blocks 101 to 110 described above can be configured by any of hardware, a digital signal processor (DSP), and software. For example, in the case being configured by software, each of the functional blocks 101 to 110 described above is actually configured by including a CPU, a RAM, a ROM, and the like of a computer, and is attained by operating a program stored in a recording medium such as a RAM, a ROM, a hard disk, or a semiconductor memory. In particular, the functions of the functional blocks 104, and 107 to 110 are attained by operating a face image generation information providing program.

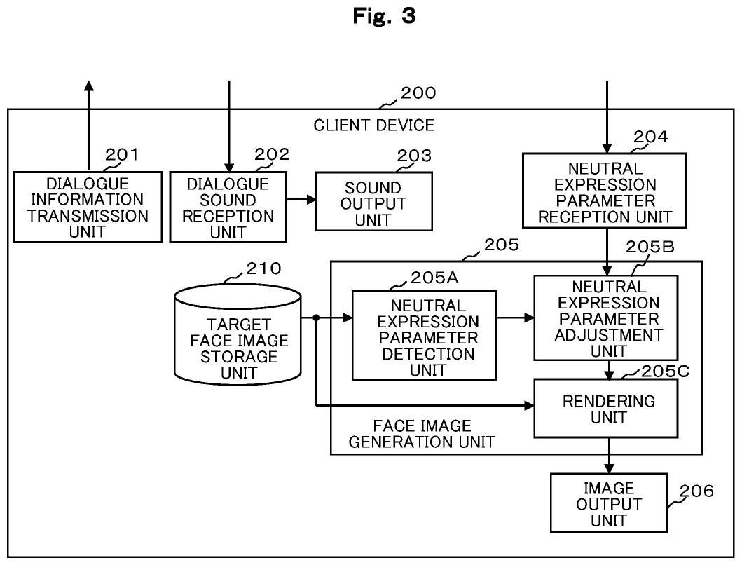

FIG. 3 is a block diagram illustrating a functional configuration example of the client device 200 according to this embodiment. As illustrated in FIG. 3, the client device 200 according to this embodiment includes a dialogue information transmission unit 201, a dialogue sound reception unit 202, a sound output unit 203, a neutral expression parameter reception unit 204, a face image generation unit 205, and an image output unit 206, as a functional configuration. The face image generation unit 205 includes a neutral expression parameter detection unit 205A, a neutral expression parameter adjustment unit 205B, and a rendering unit 205C, as a more specific functional configuration. In addition, the client device 200 includes a target face image storage unit 210 as a storage medium.

Each of the functional blocks 201 to 206 described above can also be configured by any of hardware, DSP, and software. For example, in the case of being configured by software, each of the functional blocks 201 to 206 described above is actually configured by including a CPU, a RAM, a ROM, and the like of a computer, and is attained by operating a program stored in a recording medium such as a RAM, a ROM, a hard disk, or a semiconductor memory.

The dialogue information transmission unit 201 of the client device 200 transmits the dialogue information input to the client device 200 by the user to the server device 100. As described above, the dialogue information is information relevant to the question or the request with respect to the server device 100, the response with respect to the question from the server device 100, and a natural conversation such as a small talk, and the format of the information is text information, speaking sound information, a tone signal, other control signals, and the like.

The dialogue information reception unit 101 of the server device 100 receives the dialogue information sent from the client device 200. The dialogue sound generation unit 102 generates a dialogue sound to be used in the response with respect to the dialogue information received by the dialogue information reception unit 101. As described above, the dialogue sound generation unit 102 analyzes the dialogue information sent from the client device 200 by using the predetermined rule-based or machine-learned analysis model, and generates the text information for a response corresponding to the dialogue information. Then, the dialogue sound generation unit 102 generates the synthetic sound from the text information, and outputs the synthetic sound as the dialogue sound. Hereinafter, the dialogue sound generated by using the chatbot function of the server device 100 as described above may be referred to as a “bot sound”.

The dialogue sound transmission unit 103 transmits the dialogue sound (the bot sound) generated by the dialogue sound generation unit 102 to the client device 200. The dialogue sound reception unit 202 of the client device 200 receives the dialogue sound (the bot sound) transmitted from the server device 100. The sound output unit 203 outputs the dialogue sound (the bot sound) received by the dialogue sound reception unit 202 from a speaker that is not illustrated.

The estimation neutral expression parameter generation unit 104 of the server device 100 generates an estimation neutral expression parameter indicating a face neutral expression estimated from the dialogue sound, on the basis of the dialogue sound generated by the dialogue sound generation unit 102. For example, the estimation neutral expression parameter generation unit 104 may set a neutral expression estimation model in which a neural network is machine-learned such that the face neutral expression is estimated from the dialogue sound and the neutral expression parameter is output. Then, the estimation neutral expression parameter generation unit 104 inputs the dialogue sound generated by the dialogue sound generation unit 102 to the neutral expression estimation model, thereby generating the estimation neutral expression parameter indicating the face neutral expression estimated from the dialogue sound.

The estimation neutral expression parameter generated by the estimation neutral expression parameter generation unit 104, for example, is information that is capable of specifying the movement of each part of the face such as the eyes, the nose, the mouth, the eyebrows, and the cheeks. The movement of each part is a change between the position and the shape of each part at a certain sampling time t and the position and the shape of each part at the next sampling time t+1. The neutral expression parameter that is capable of specifying the movement, for example, may be information indicating the position and the shape of each part of the face for each sampling time. Alternatively, the neutral expression parameter may be vector information indicating a change in the position and the shape during the sampling time.

The estimation neutral expression parameter generation unit 104, for example, specifies the dialogue contents by performing sound recognition and natural language analysis with respect to the dialogue sound, and inputs information indicating the dialogue contents to the neutral expression estimation model, thereby generating the estimation neutral expression parameter indicating the movement of the mouth according to the dialogue contents. In addition, the estimation neutral expression parameter generation unit 104 estimates the emotion by performing acoustic analysis with respect to the dialogue sound, and inputs information indicating the emotion to the neutral expression estimation model, thereby generating the estimation neutral expression parameter indicating the movement of each part according to the emotion. The estimation of the emotion may be performed in consideration of the dialogue contents specified by performing the sound recognition and the natural language analysis with respect to the dialogue sound, in addition to the result of the acoustic analysis with respect to the dialogue sound.

The captured face image input unit 105 inputs a captured face image obtained by capturing the face of the person with a camera that is not illustrated. In this embodiment, the person is an operator performing a dialogue with the user of the client device 200, instead of the chatbot (the dialogue sound generated by the dialogue sound generation unit 102). As described below, in this embodiment, as an example, the dialogue is performed between the chatbot and the user in the initial state, but in a predetermined state, the operator performs the dialogue with the user instead of the chatbot. The captured face image input unit 105 inputs the captured face image when the operator performs the dialogue with the user by the camera (installed in a location where the operator exists) as a moving image.

When the operator performs the dialogue with the user instead of the chatbot, the sound input unit 106 inputs the speaking sound of the operator from a microphone (installed in the location where the operator exists) that is not illustrated. Hereinafter, dialogue sound input by the sound input unit 106 when the operator performs the dialogue with the user of the client device 200 as described above may be referred to as an “operator sound”. The dialogue sound (the operator sound) input by the sound input unit 106 is transmitted to the client device 200 by the dialogue sound transmission unit 103.

The appearance neutral expression parameter generation unit 107 generates an appearance neutral expression parameter indicating a face neutral expression appearing on the captured face image, on the basis of the captured face image input by the captured face image input unit 105. In particular, the appearance neutral expression parameter generation unit 107 analyzes the captured face image when the speaking sound of the operator is input by the sound input unit 106, thereby generating the appearance neutral expression parameter indicating the face neutral expression appearing on the captured face image.

For example, the appearance neutral expression parameter generation unit 107 sets a neutral expression detection model in which the neural network is machine-learned such that the neutral expression parameter indicating the position and the shape of each part of the face is output from the face image. Then, the appearance neutral expression parameter generation unit 107 inputs the captured face image input by the captured face image input unit 105 as the moving image to the neutral expression detection model for each frame, thereby detecting a neutral expression parameter indicating the face neutral expression from the captured face image for each frame. In this case, the neutral expression parameter is information indicating the position and the shape of each part of the face for each frame.

Note that, the appearance neutral expression parameter generation unit 107 may generate the vector information indicating a change between frames with respect to the position and the shape of each part by using the information indicating the position and the shape of each part of the face for each frame to be generated as the appearance neutral expression parameter.

The neutral expression parameter selection unit 108 selects either the estimation neutral expression parameter generated by the estimation neutral expression parameter generation unit 104 or the appearance neutral expression parameter generated by the appearance neutral expression parameter generation unit 107. As an example, the neutral expression parameter selection unit 108 selects the estimation neutral expression parameter when the chatbot performs the dialogue with the user in the initial state, and selects the appearance neutral expression parameter when the operator performs the dialogue with the user.

The switch to the dialogue of the operator from the dialogue of the chatbot is performed on the basis of a determination result of the state determination unit 109. The state determination unit 109 determines whether it is the predetermined state in association with at least one of the dialogue information received by the dialogue information reception unit 101 from the client device 200 and of the dialogue sound generated by the dialogue sound generation unit 102. The neutral expression parameter selection unit 108 selects the estimation neutral expression parameter in the initial state, and switches the selection to the appearance neutral expression parameter from the estimation neutral expression parameter in a case where the state determination unit 109 determines that it is the predetermined state.

For example, the state determination unit 109 determines whether it is a state where the dialogue sound can be generated in response to the dialogue information. As an example, in a case where the dialogue information transmitted from the client device 200 is the speaking sound information input to the client device 200 by the user using the microphone, the state determination unit 109 determines whether the meaning of the speaking sound can be interpreted by the sound recognition. Then, in a case where the state determination unit 109 determines that it is not a state where the dialogue sound can be generated, the neutral expression parameter selection unit 108 switches the selection to the appearance neutral expression parameter from the estimation neutral expression parameter.

The state determination unit 109, for example, determines that it is a state where the dialogue sound is not capable of being generated in the following cases.

(1) A case where the volume of the speaking sound received by the dialogue information reception unit 101 is low and the sound recognition is not available.

(2) A case where the accent of the speaking sound is thick and the sound recognition is not available.

(3) A case where the sound recognition is available, but the meaning of the speaking contents is not capable of being interpreted only by dictionary data prepared in advance.

(4) A case where the speaking contents are not associated with a task applied in advance to the chatbot, and thus, the meaning is not capable of being interpreted. (4) is a determination condition that can be applied even in a case where the dialogue information is sent as the text information.

As another example, the state determination unit 109 may determine whether the contents of the dialogue information received by the dialogue information reception unit 101 are contents that require the response of the operator but not the response of the dialogue sound. In a case where the state determination unit 109 determines that the dialogue information is the contents that require the response of the operator, the neutral expression parameter selection unit 108 switches the selection to the appearance neutral expression parameter from the estimation neutral expression parameter.

As still another example, the state determination unit 109 may determine whether the content of the dialogue information received by the dialogue information reception unit 101 or the contents of the dialogue sound generated by the dialogue sound generation unit 102 satisfy a condition set in advance. For example, in accordance with the contents of the dialogue information, a condition handled by the chatbot and a condition handled by the operator are set, and the state determination unit 109 determines which condition is satisfied. Alternatively, in accordance with the contents of the dialogue sound, a condition continuously handled by the chatbot and a condition switched to be handled by the operator are set, and the state determination unit 109 determines which condition is satisfied. Then, in a case where the state determination unit 109 determines that the operator satisfied the corresponding condition, the neutral expression parameter selection unit 108 switches the selection to the appearance neutral expression parameter from the estimation neutral expression parameter.

The state determination unit 109 instructs the neutral expression parameter selection unit 108 to switch the selection to the appearance neutral expression parameter from the estimation neutral expression parameter, instructs the dialogue sound generation unit 102 to stop the processing of the dialogue sound generation unit 102, and instructs the dialogue sound transmission unit 103 to switch the dialogue sound transmitted to the client device 200 to the operator sound from the bot sound. By receiving such an instruction, the dialogue sound transmission unit 103 transmits the operator sound input by the sound input unit 106 to the client device 200, instead of the bot sound generated by the dialogue sound generation unit 102.

Note that, when the dialogue sound transmitted to the client device 200 is switched to the operator sound from the bot sound, an announcement sound of that effect may be transmitted to the client device 200 from the dialogue sound transmission unit 103. In addition, in a case where there are a plurality of waiting operators, an operator carrying on the dialogue from the chatbot may be searched and selected, and a notification may be performed with respect to the selected operator. In this case, the dialogue history of the chatbot, information collected from the user during the dialogue of the chatbot, and the like may be displayed on a terminal used by the operator who receives the notification and performs an acceptance manipulation.

After an interlocutor of the user is switched to the operator from the chatbot, the operator is capable of recognizing the dialogue information received by the dialogue information reception unit 101. For example, in a case where the dialogue information received by the dialogue information reception unit 101 is the speaking sound information of the user, the speaking sound is output from a speaker for the operator. In addition, in a case where the dialogue information is the text information, the tone signal, or the control signal, contents indicated by the information are displayed on a display for the operator. Accordingly, the operator is capable of continuously performing the dialogue with respect to the dialogue information of the user, which is continuously sent from the client device 200.

The neutral expression parameter transmission unit 110 transmits either the estimation neutral expression parameter or the appearance neutral expression parameter selected by the neutral expression parameter selection unit 108 to the client device 200. Here, the estimation neutral expression parameter is generated on the basis of the bot sound transmitted by the dialogue sound transmission unit 103. Therefore, the neutral expression parameter transmission unit 110 transmits the estimation neutral expression parameter generated by the estimation neutral expression parameter generation unit 104 to the client device 200 to be synchronized with the bot sound transmitted by the dialogue sound transmission unit 103 (or in association with the bot sound).

In addition, the appearance neutral expression parameter is generated from the captured face image input by the captured face image input unit 105 when the operator sound is input from the sound input unit 106. Therefore, the neutral expression parameter transmission unit 110 transmits the appearance neutral expression parameter generated by the estimation neutral expression parameter generation unit 104 to the client device 200 to be synchronized with the operator sound transmitted by the dialogue sound transmission unit 103 (or in association with the operator sound).

The neutral expression parameter reception unit 204 of the client device 200 receives either the estimation neutral expression parameter or the appearance neutral expression parameter transmitted from the server device 100. The face image generation unit 205 applies the neutral expression specified on the basis of either the estimation neutral expression parameter or the appearance neutral expression parameter received by the neutral expression parameter reception unit 204 to the target face image stored in advance in the target face image storage unit 210, thereby generating the face image of the neutral expression corresponding to the bot sound or the captured face image of the operator. The image output unit 206 displays the face image generated by the face image generation unit 205 on a display that is not illustrated.

The target face image stored in advance in the target face image storage unit 210, for example, is the captured image of any figure. The neutral expression of the target face image may be any neutral expression, and for example, can be a face image of an unreadable neutral expression without emotions. As the target face image, a face image desired by the user may be set. For example, the own face image, a face image of a favorite celebrity, a face image of a favorite painting, and the like may be freely set. Note that, here, an example of using the captured image has been described, but a face image or a CG image of a character appearing in a favorite manga may be used.

The neutral expression parameter detection unit 205A of the face image generation unit 205 analyzes the target face image stored in the target face image storage unit 210, thereby detecting the neutral expression parameter indicating the face neutral expression of the target face image. For example, the neutral expression parameter detection unit 205A sets the neutral expression detection model in which the neural network is machine-learned such that the neutral expression parameter indicating the position and the shape of each part of the face from the face image is output. Then, the neutral expression parameter detection unit 205A inputs the target face image stored in the target face image storage unit 210 to the neutral expression detection model, thereby detecting the neutral expression parameter indicating the face neutral expression from the target face image.

The neutral expression parameter adjustment unit 205B adjusts the neutral expression parameter of the target face image that is detected by the neutral expression parameter detection unit 205A with the estimation neutral expression parameter or the appearance neutral expression parameter received by the neutral expression parameter reception unit 204. For example, the neutral expression parameter adjustment unit 205B adds a change to the neutral expression parameter of the target face image such that each part of the face in the target face image is deformed in accordance with the movement of each part of the face indicated by the estimation neutral expression parameter or the appearance neutral expression parameter.

The rendering unit 205C generates a face image in which the neutral expression corresponding to the bot sound or the captured face image of the operator is applied to the target face image (that is, a face image in which the neutral expression of the target face image is corrected to a neutral expression corresponding to the neutral expression estimated from the bot sound or the actual neutral expression of the operator) by using the neutral expression parameter of the target face image that is adjusted by the target face image stored in the target face image storage unit 210 and the neutral expression parameter adjustment unit 205B.

The rendering unit 205C not only corrects the position, the shape, and the size of each part indicated by the neutral expression parameter but also corrects the peripheral region thereof in accordance with the correction of each part such that the entire face image is naturally moved. In addition, in a case where the target face image is in a state where the mouth is closed, but is in a state where the mouth is opened, which is adjusted on the basis of the neutral expression parameter, an image of the inside of the mouth is supplemented and generated.

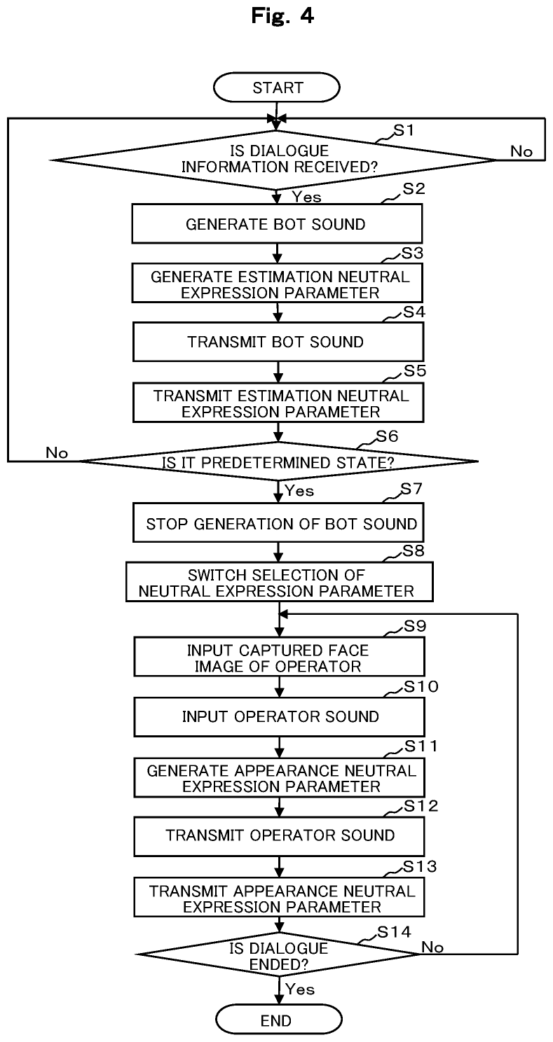

FIG. 4 is a flowchart illustrating an operation example of the server device 100 according to this embodiment that is configured as described above. The flowchart illustrated in FIG. 4 is started with the reception of the initial dialogue information from the client device 200 as a trigger when the server device 100 is waiting as the initial state. Note that, in the initial state, the neutral expression parameter selection unit 108 is set in a state where the transmission of the estimation neutral expression parameter to the client device 200 is selected.

First, the dialogue information reception unit 101 of the server device 100 determines whether the dialogue information of the user is received from the client device 200 (step S1). In a case where the dialogue information is not received, the dialogue information reception unit 101 continuously performs the determination of step S1.

On the other hand, in a case where the dialogue information reception unit 101 receives the dialogue information from the client device 200, the dialogue sound generation unit 102 generates the dialogue sound (the bot sound) to be used in the response with respect to the received dialogue information (step S2). In addition, the estimation neutral expression parameter generation unit 104 generates the estimation neutral expression parameter indicating the face neutral expression estimated from the bot sound, on the basis of the bot sound generated by the dialogue sound generation unit 102 (step S3).

Next, the bot sound generated by the dialogue sound generation unit 102 is transmitted to the client device 200 by the dialogue sound transmission unit 103 (step S4), and the estimation neutral expression parameter generated by the estimation neutral expression parameter generation unit 104 is transmitted to the client device 200 by the neutral expression parameter transmission unit 110 (step S5).

After that, the state determination unit 109 determines whether it is the predetermined state in association with at least one of the dialogue information of the user and the bot sound generated therefrom (step S6). Here, in a case where the state determination unit 109 determines that it is not the predetermined state, the processing returns to step Si.

On the other hand, in a case where the state determination unit 109 determines that it is the predetermined state, the dialogue sound generation unit 102 stops the processing of generating the bot sound, in accordance with the instruction from the state determination unit 109 (step S7), and the neutral expression parameter selection unit 108 switches the selection to the appearance neutral expression parameter from the estimation neutral expression parameter selected in the initial state, in accordance with the instruction from the state determination unit 109 (step S8).

Next, the captured face image input unit 105 inputs the captured face image of the operator by the camera (step S9), and the sound input unit 106 inputs the speaking sound of the operator by the microphone (step S10). Then, the appearance neutral expression parameter generation unit 107 generates the appearance neutral expression parameter indicating the face neutral expression appearing on the captured face image, on the basis of the captured face image input by the captured face image input unit 105 (step S11).

Then, the operator sound input by the sound input unit 106 is transmitted to the client device 200 by the dialogue sound transmission unit 103 (step S12), and the appearance neutral expression parameter generated by the appearance neutral expression parameter generation unit 107 is transmitted to the client device 200 by the neutral expression parameter transmission unit 110, instead of the previous estimation neutral expression parameter (step S13).

While the operator carries on the dialogue with the user from the chatbot, the dialogue information of the user that is received by the dialogue information reception unit 101 is represented to the operator. That is, in a case where the dialogue information received by the dialogue information reception unit 101 is the speaking sound information of the user, the speaking sound is output from the speaker for the operator, and in a case where the dialogue information is the text information, the text is displayed on the display for the operator. Accordingly, the operator is capable of continuously performing the dialogue with respect to the dialogue information of the user.

After the processing of step S13 described above, the server device 100 determines whether the dialogue processing with the client device 200 is ended (step S14). A case where the dialogue processing is ended, for example, is a case where the user or the operator determines that the task required by the user is ended or it is difficult to continue the task by a set of dialogue processing pieces, and the user or the operator instructs the end of the dialogue processing. In a case where the end of the dialogue processing is not instructed, the processing returns to step S9. On the other hand, in a case where the end of the dialogue processing is instructed, the processing of the flowchart illustrated in FIG. 4 is ended.

Note that, here, an example has been described in which the dialogue between the user and the operator is switched from the dialogue between the user and the chatbot, and then, the dialogue processing is ended in accordance with the instruction of the user or the operator, but the invention is not limited thereto. For example, when the task required by the user is ended to the last or when a part of the task required by the user is ended (for example, a case where a task that is difficult to handle in the chatbot is ended in the dialogue with the operator), the dialogue with the operator may return to the dialogue with the chatbot.

In this case, the dialogue sound generation unit 102 restarts the processing of generating the bot sound, and the neutral expression parameter selection unit 108 switches the selection to the estimation neutral expression parameter from the appearance neutral expression parameter. When the processing of the dialogue sound generation unit 102 is restarted, the bot sound generated first may be designated by the operator. As an example, it is considered that the operator designates the bot sound at any stage in a dialogue scenario set in advance. After the processing of the dialogue sound generation unit 102 is restarted, the dialogue sound generation unit 102 may automatically determine the contents of the bot sound in accordance with a predetermined rule, instead of the operator designating the bot sound generated first.

As described above in detail, in this embodiment, when the dialogue is performed between the user of the client device 200 and the chatbot of the server device 100, in the server device 100, the estimation neutral expression parameter indicating the face neutral expression estimated from the dialogue sound is generated by the estimation neutral expression parameter generation unit 104, on the basis of the dialogue sound (the bot sound) generated in accordance with the dialogue information of the user, which is sent from the client device 200, and is transmitted to the client device 200. On the other hand, when the dialogue is performed between the user of the client device 200 and the operator on the server device 100 side, in the server device 100, the appearance neutral expression parameter indicating the face neutral expression appearing on the captured face image is generated by the appearance neutral expression parameter generation unit 107, on the basis of the captured face image obtained by capturing the face of the operator, and is transmitted to the client device 200. Then, in the client device 200, the neutral expression specified on the basis of the neutral expression parameter transmitted from the server device 100 is applied to the target face image, and thus, the face image of the neutral expression corresponding to the bot sound or the captured face image of the operator is generated and displayed.

According to this embodiment configured as described above, in a situation where the dialogue is performed between the user of the client device 200 and the chatbot of the server device 100 or the dialogue is performed between the user of the client device 200 and the operator on the server device 100 side, the face image in which the neutral expression is adjusted to correspond to either the bot sound or the captured face image of the operator can be generated in the client device 200. Accordingly, according to this embodiment, the face image in which the neutral expression is adjusted in accordance with the situation when the dialogue is performed can be displayed on the client device 200. In this case, a face image in which the neutral expression is adjusted with respect to a favorite target face image selected by the user can be generated and displayed.

In addition, in this embodiment, when the dialogue is performed between the user of the client device 200 and the operator on the server device 100 side, the estimation neutral expression parameter indicating the face neutral expression estimated from the operator sound is not generated, but the appearance neutral expression parameter indicating the actual face neutral expression of the operator is generated on the basis of the captured face image obtained by capturing the face of the operator. Accordingly, when the user performs the dialogue with the operator, a face image of a more realistic neutral expression according to the contents or the atmosphere of the dialogue at this time, the emotion of the speaker, and the like can be displayed.

Note that, in the embodiment described above, an example has been described in which the target face image is stored in advance in the target face image storage unit 210 of the client device 200, but the invention is not limited thereto. For example, the target face image may be transmitted to the client device 200 from the server device 100 together with the neutral expression parameter.

In addition, in the embodiment described above, an example has been described in which the interlocutor of the user is the chatbot in the initial state of the dialogue, and the chatbot is switched to the operator, but the invention is not limited thereto. For example, the embodiment described above can also be applied to a case where the interlocutor of the user is the operator in the initial state of the dialogue, and the operator is switched to the chatbot. In addition, the embodiment described above can also be applied to a case where the chatbot and the operator are alternately switched to continue the dialogue.

In addition, the embodiment described above merely indicates an example for specifically implementing the invention, and the technical scope of the invention is not construed to be limited by the embodiment. That is, the invention can be implemented in various forms without departing from the gist thereof or the main characteristics.

### REFERENCE SIGNS LIST

100: server device
101: dialogue information reception unit
102: dialogue sound generation unit
103: dialogue sound transmission unit
104: estimation neutral expression parameter generation unit
105: captured face image input unit
106: sound input unit
107: appearance neutral expression parameter generation unit
108: neutral expression parameter selection unit
109: state determination unit
110: neutral expression parameter transmission unit
200: client device
201: dialogue information transmission unit
202: dialogue sound reception unit
203: sound output unit
204: neutral expression parameter reception unit
205: face image generation unit
205A: neutral expression parameter detection unit
205B: neutral expression parameter adjustment unit
205C: rendering unit
206: image output unit
210: target face image storage unit

1. A face image processing system in which a server device and a client device are connected through a communication network, characterized in that
the server device includes:
a dialogue sound generation unit generating a dialogue sound to be used in a response with respect to dialogue information of a user, which is sent from the client device;
an estimation neutral expression parameter generation unit generating an estimation neutral expression parameter indicating a face neutral expression estimated from the dialogue sound, on the basis of the dialogue sound generated by the dialogue sound generation unit;
a captured face image input unit inputting a captured face image obtained by capturing a face of a person;
an appearance neutral expression parameter generation unit generating an appearance neutral expression parameter indicating a face neutral expression appearing on the captured face image, on the basis of the captured face image input by the captured face image input unit;
a neutral expression parameter selection unit selecting either the estimation neutral expression parameter generated by the estimation neutral expression parameter generation unit or the appearance neutral expression parameter generated by the appearance neutral expression parameter generation unit; and
a neutral expression parameter transmission unit transmitting either the estimation neutral expression parameter or the appearance neutral expression parameter selected by the neutral expression parameter selection unit to the client device, and
the client device includes:
a neutral expression parameter reception unit receiving either the estimation neutral expression parameter or the appearance neutral expression parameter transmitted from the server device; and
a face image generation unit generating a face image of a neutral expression corresponding to the dialogue sound or the captured face image by applying a neutral expression specified on the basis of either the estimation neutral expression parameter or the appearance neutral expression parameter received by the neutral expression parameter reception unit to a target face image.

2. The face image processing system according to claim 1, characterized in that the server device further includes a state determination unit determining whether it is a predetermined state in association with at least one of the dialogue information and the dialogue sound, and
the neutral expression parameter selection unit selects either estimation neutral expression parameter or the appearance neutral expression parameter in accordance with a determination result of the state determination unit.

3. The face image processing system according to claim 2, characterized in that the state determination unit determines whether the dialogue sound can be generated in response to the dialogue information, and
the neutral expression parameter selection unit selects the appearance neutral expression parameter when the state determination unit determines that the dialogue sound is not capable of being generated in response to the dialogue information.

4. The face image processing system according to claim 2, characterized in that the state determination unit determines whether contents of the dialogue information are contents for requiring a response of the person but not a response of the dialogue sound, and
the neutral expression parameter selection unit selects the appearance neutral expression parameter when the state determination unit determines that the contents of the dialogue information are the contents for requiring the response of the person.

5. The face image processing system according to claim 2, characterized in that the state determination unit determines whether contents of the dialogue information or contents of the dialogue sound satisfy a condition set in advance, and
the neutral expression parameter selection unit selects the appearance neutral expression parameter when the state determination unit determines that the contents of the dialogue information or the contents of the dialogue sound satisfy the condition set in advance.

6. A face image generation information providing apparatus providing a neutral expression parameter for generating a face image to a client device such that the client device is capable of generating a face image of a neutral expression specified on the basis of the neutral expression parameter, characterized by comprising:
an estimation neutral expression parameter generation unit generating an estimation neutral expression parameter indicating a face neutral expression estimated from a dialogue sound generated by a computer, on the basis of the dialogue sound;
an appearance neutral expression parameter generation unit generating an appearance neutral expression parameter indicating a face neutral expression appearing on a captured face image obtained by capturing a face of a person, on the basis of the captured face image;
a neutral expression parameter selection unit selecting either the estimation neutral expression parameter generated by the estimation neutral expression parameter generation unit or the appearance neutral expression parameter generated by the appearance neutral expression parameter generation unit; and
a neutral expression parameter transmission unit transmitting either the estimation neutral expression parameter or the appearance neutral expression parameter selected by the neutral expression parameter selection unit to the client device.

7. The face image generation information providing apparatus according to claim 6, characterized by further comprising:
a dialogue sound generation unit generating the dialogue sound to be used in a response with respect to dialogue information of a user, which is sent from the client device; and
a state determination unit determining whether it is a predetermined state in association with at least one of the dialogue information and the dialogue sound,
wherein the neutral expression parameter selection unit selects either the estimation neutral expression parameter or the appearance neutral expression parameter in accordance with a determination result of the state determination unit.

8. A face image generation information providing method for providing a neutral expression parameter for generating a face image to a client device such that the client device is capable of generating a face image of a neutral expression specified on the basis of the neutral expression parameter, characterized by comprising:
a first step of allowing a dialogue sound generation unit of a computer to generate a dialogue sound to be used in a response with respect to dialogue information of a user, which is sent from the client device;
a second step of allowing an estimation neutral expression parameter generation unit of the computer to generate an estimation neutral expression parameter indicating a face neutral expression estimated from the dialogue sound, on the basis of the dialogue sound generated by the dialogue sound generation unit;
a third step of allowing a neutral expression parameter transmission unit of the computer to transmit the estimation neutral expression parameter generated by the estimation neutral expression parameter generation unit to the client device;
a fourth step of allowing a state determination unit of the computer to determine whether it is a predetermined state in association with at least one of the dialogue information and the dialogue sound;
a fifth step of allowing a neutral expression parameter selection unit of the computer to switch a selection from the estimation neutral expression parameter to an appearance neutral expression parameter when the state determination unit determines that it is the predetermined state;
a sixth step of allowing a captured face image input unit of the computer to input a captured face image obtained by capturing a face of a person when the state determination unit determines that it is the predetermined state;
a seventh step of allowing an appearance neutral expression parameter generation unit of the computer to generate the appearance neutral expression parameter indicating a face neutral expression appearing on the captured face image, on the basis of the captured face image input by the captured face image input unit; and
an eighth step of allowing the neutral expression parameter transmission unit of the computer to transmit the appearance neutral expression parameter to the client device, instead of the estimation neutral expression parameter.

9. A face image generation information providing program for allowing a computer to execute processing of providing a neutral expression parameter for generating a face image to a client device such that the client device is capable of generating a face image of a neutral expression specified on the basis of the neutral expression parameter, the program for allowing the computer to function as:
an estimation neutral expression parameter generation unit generating an estimation neutral expression parameter indicating a face neutral expression estimated from a dialogue sound generated by the computer, on the basis of the dialogue sound;
an appearance neutral expression parameter generation unit generating an appearance neutral expression parameter indicating a face neutral expression appearing on a captured face image obtained by capturing a face of a person, on the basis of the captured face image;
a neutral expression parameter selection unit selecting either the estimation neutral expression parameter generated by the estimation neutral expression parameter generation unit or the appearance neutral expression parameter generated by the appearance neutral expression parameter generation unit; and
a neutral expression parameter transmission unit transmitting either the estimation neutral expression parameter or the appearance neutral expression parameter selected by the neutral expression parameter selection unit to the client device.
